(19) United States
(12) Patent Application Publication
(10) Pub. No.: US 2025/0004955 A1
(43) Pub. Date: Jan. 2, 2025

(54) Programmable Input/Output Dies for Specialization in Disaggregated Systems

(71) Applicant: Advanced Micro Devices, Inc., Santa Clara, CA (US)

(72) Inventors: Anthony Thomas Gutierrez, Seattle, WA (US); Todd David Basso, Arlington, MA (US); Gabriel Hsiuwei Loh, Bellevue, WA (US)

(73) Assignee: Advanced Micro Devices, Inc., Santa Clara, CA (US)

(21) Appl. No.: 18/215,519

(22) Filed: Jun. 28, 2023

(51) Int. Cl. G06F 13/16; G06F 13/366

(52) U.S. Cl. CPC G06F 13/1668; G06F 13/1626; G06F 13/366

(57) ABSTRACT

Programmable I/O die devices and methods are described. An example system includes an input/output die (IOD) that couples a plurality of devices. The system also includes a programmable fabric included in the IOD. The programmable fabric implements interconnects for connecting the plurality of devices according to a reconfigurable topology defined by a configuration of the programmable fabric.

### BACKGROUND

In modern disaggregated computing system architectures, a processing unit is implemented by connecting multiple chiplets (e.g., semiconductor dies) in a package (e.g., chip) to collectively compose the functionality of the processing unit. Each chiplet in a multi-chiplet package typically includes circuitry implementing a specific contribution to an overall functionality of the processing unit. As more devices such as accelerators are incorporated in modern computing systems, customization becomes a key factor in determining cost, scalability, performance, and efficiency of multi-chiplet implementations.

### BRIEF DESCRIPTION OF THE DRAWINGS

The detailed description is described with reference to the accompanying figures.

FIG. 1 is a block diagram of a non-limiting example system configured to employ a programmable input/output die (IOD).

FIG. 2 is a block diagram of a non-limiting example system configured to implement a programmable IOD configuration specialized for a specific heterogeneous system architecture.

FIG. 3 is a block diagram of a non-limiting example system showing a programmable event signaling mechanism implemented to enable asynchronous event signaling between two accelerators in a heterogeneous system.

FIG. 4 depicts a procedure in an example implementation of a system that enables connecting a plurality of devices according to a reconfigurable topology by using a programmable IOD fabric.

FIG. 5 depicts a procedure in an example implementation of a programmable event signaling mechanism that enables asynchronous event signaling between distinct accelerators in a heterogeneous system.

### DETAILED DESCRIPTION

In multi-chiplet architectures, an input/output die (IOD) is a semiconductor die or chiplet that connects various other chiplets to one another and/or to a shared hardware resource (e.g., memory). For instance, an IOD includes circuitry, such as memory controllers and/or data buses, used to transfer data between connected system components and/or to provide access to a shared hardware resource (e.g., physical memory). For example, a central processing unit (CPU) implemented on a first chiplet and a graphics processing unit (GPU) implemented on a second chiplet can be connected to an IOD to form a package. In this example, the CPU and GPU communicate data via the IOD with each other and/or with other hardware resources (e.g., a physical memory). IOD chiplets manufactured in this manner can advantageously be employed to build a variety of different systems (e.g., chips with different CPU and/or GPU configurations). More generally, in some scenarios, multi-chiplet architectures enable reusing a same chiplet design to build a variety of different systems, thereby reducing overall system design complexity and manufacturing costs while also enabling scalability as compared to traditional system-on-chip architectures (where a whole system is instead implemented on a single semiconductor die).

As more devices with diverse requirements and capabilities (e.g., accelerators, etc.) are incorporated into multi-chiplet packages, IOD customization becomes a key factor in determining the overall cost, scalability, performance, and efficiency of a multi-chiplet system. For example, IOD designs are typically optimized for CPU and/or GPU based chiplets, but not necessarily for other types of chiplets or workloads. Although it is possible to develop an IOD that supports a wider variety of chiplets, such IOD may be associated with increased costs and/or power consumption, even if the IOD is used in a product that does not include each type of supported chiplets.

To solve these problems, devices and techniques are described that use a programmable IOD to achieve scalability and flexibility advantages of multi-chiplet architectures while enabling support for customized and/or specialized system domains. These techniques are based on providing a programmable chiplet architecture for IOD specialization. For example, some programmable IODs described herein provide specialization for a given domain, thereby enabling domain-specific compute accelerators to be attached thereto and efficiently operated by reconfiguring the IOD according to the attached accelerators. For example, IODs described herein are reconfigurable to enable customization of network-on-chip (NoC) topologies, Quality-of-Service (QoS) algorithms, confidential compute policies, schedulers, address translation services, and/or traffic routing priorities. To achieve programmability, example IODs described herein include programmable logic fabric, microcontrollers, and/or other programmable blocks.

In one example, an IOD is described that couples a plurality of devices to implement a disaggregated compute system. For instance, the plurality of devices include a host (e.g., CPU core) and one or more chiplets (e.g., semiconductor dies, chips of a chipset, etc.) that are connected to the IOD via one or more die-to-die and/or chip-to-chip interfaces. The IOD includes a programmable fabric that implements reconfigurable interconnects to connect the plurality of devices (and one or more components of the IOD) in a reconfigurable topology. In an example, the programmable fabric has a first configuration that connects one or more components (e.g., GPUs, CPUs, etc.) of the plurality of devices in a first network topology (e.g., mesh, tree, etc.). The programmable fabric, in this example, is reconfigurable (e.g., via a BIOS update, etc.) to have a second configuration that connects the one or more components in a different second network topology.

In examples, the programmable fabric connects other components therein along a data path defined by the interconnects between two or more of the plurality of devices. In an example, the IOD includes a programmable data mover connected along the data path to perform a data operation (e.g., encryption, compression, etc.) in-line on data transferred along the data path prior to the data being transferred out of the IOD.

In an example, the IOD includes a programmable core (e.g., scalar core or other processor) that implements reconfigurable (e.g., software-defined, etc.) memory management functionalities (e.g., QoS policies, prefetching algorithms, memory access pattern detection algorithms, memory access request prioritization and/or arbitration policies, etc.) and/or other programmable functionalities (e.g., task scheduling for attached hardware resources, etc.). Thus, for instance, the programmable core can be used to perform customized operations in-line to facilitate efficient execution of a specialized parallel processing acceleration process without necessarily needing a software interrupt from the host. Conventionally, for example, processes such as task scheduling are implemented by the host using software interrupts. The example IOD enables alternatively performing such operations in-line to optimize a heterogeneous or hybrid configuration without requiring computationally expensive interrupts from the host.

In an example, the IOD includes a programmable event block that enables asynchronous event signaling among two or more of the plurality of devices (e.g., without intervention from a host). For instance, a first accelerator can send a signal (e.g., virtual address) to the programmable event block that triggers a given IOD operation, such as triggering the IOD to enqueue execution of a task by a second accelerator (e.g., without interruption from the host). Other example IOD operations triggered by receipt of the signal at the programmable event block include updating a QoS policy or arbitration policy applied by the IOD, updating a memory bandwidth assigned to a particular device of the plurality of devices, among other possibilities.

In an example, the IOD includes a programmable platform controller (e.g., virtual device configuration manager) configured to provide Root-of-Trust (RoT) and configure or compose a virtual hardware resource for a workload. Conventionally, this functionality is typically performed by a host via software interrupts. However, he example IOD advantageously enables composing virtual devices on the IOD so as to securely and efficiently implement input/output (IO) virtualization on the hardware of the IOD instead of on the host.

In some aspects, the techniques described herein relate to a system including: an input/output die (IOD) that couples a plurality of devices; and a programmable fabric included in the IOD, the programmable fabric configured to implement interconnects for connecting the plurality of devices according to a reconfigurable topology defined by a configuration of the programmable fabric.

In some aspects, the techniques described herein relate to a system, wherein the plurality of devices includes one or more chiplets coupled via the IOD to implement a disaggregated hardware resource accessible to a host via the IOD.

In some aspects, the techniques described herein relate to a system, further including: a programmable data mover included in the IOD, the programmable data mover implemented along a data path defined by the interconnects based on the configuration of the programmable fabric, the programmable data mover configured to perform a data operation on data transferred along the data path.

In some aspects, the techniques described herein relate to a system, wherein the data operation includes encryption or compression of the data prior to transferring the data out of the IOD.

In some aspects, the techniques described herein relate to a system, further including: a programmable core included in the IOD, the programmable core configured to control memory access operations for accessing a physical memory via the IOD.

In some aspects, the techniques described herein relate to a system, wherein the programmable core is configured to control access to the physical memory by the plurality of devices according to a reconfigurable quality-of-service policy or a reconfigurable arbitration policy.

In some aspects, the techniques described herein relate to a system, wherein the programmable core is configured to prefetch data from the physical memory according to a programmable prefetching configuration.

In some aspects, the techniques described herein relate to a system, wherein the programmable core is configured to schedule memory requests from the plurality of devices according to a programmable scheduling configuration.

In some aspects, the techniques described herein relate to a system, wherein the programmable core is configured to manage address translation service (ATS) requests from the plurality of devices according to a programmable ATS configuration.

In some aspects, the techniques described herein relate to a system, further including: a programmable event block included in the IOD, the programmable event block configured to: receive a signal from a first device of the plurality of devices; and trigger performance of an operation in response to receipt of the signal.

In some aspects, the techniques described herein relate to a system, wherein the first device is a first accelerator of the plurality of devices and a second device of the plurality of devices is a second accelerator, wherein the operation includes the IOD to enqueue a task for execution by the second accelerator in response to the receipt of the signal from the first accelerator.

In some aspects, the techniques described herein relate to a system, further including: a programmable platform controller included in the IOD, the programmable platform controller configured to compose one or more of the plurality of devices into a configuration that implements a virtual hardware resource for executing a workload.

In some aspects, the techniques described herein relate to a system, wherein the programmable platform controller is configured to provide a root-of-trust for composition of the plurality of devices to implement one or more virtual hardware resources.

In some aspects, the techniques described herein relate to a method including: connecting, via a programmable fabric included in an input/output die (IOD), a plurality of devices according to a reconfigurable topology defined by a configuration of the programmable fabric.

In some aspects, the techniques described herein relate to a method, further including: performing, at a programmable data mover included in the IOD along a data path defined by the programmable fabric, a data operation on data transferred along the data path.

In some aspects, the techniques described herein relate to a method, further including: controlling, by a programmable core included in the IOD, memory access operations for accessing a physical memory via the IOD.

In some aspects, the techniques described herein relate to a method, further including: receiving, at a programmable event block included in the IOD, a signal from a first accelerator connected to the IOD; and in response to receipt of the signal, enqueue a task for execution by a second accelerator connected to the IOD.

In some aspects, the techniques described herein relate to a method, further including: composing, via a programmable platform controller included in the IOD, one or more of the plurality of devices into a configuration that implements a virtual hardware resource for executing a workload.

In some aspects, the techniques described herein relate to an input/output die (IOD) including: a programmable fabric configured to implement interconnects for connecting a plurality of devices according to a reconfigurable topology defined by a configuration of the programmable fabric.

In some aspects, the techniques described herein relate to an IOD, wherein the plurality of devices include a host and one or more chiplets, wherein the one or more chiplets are coupled via the IOD to implement a disaggregated hardware resource accessible to the host via the IOD.

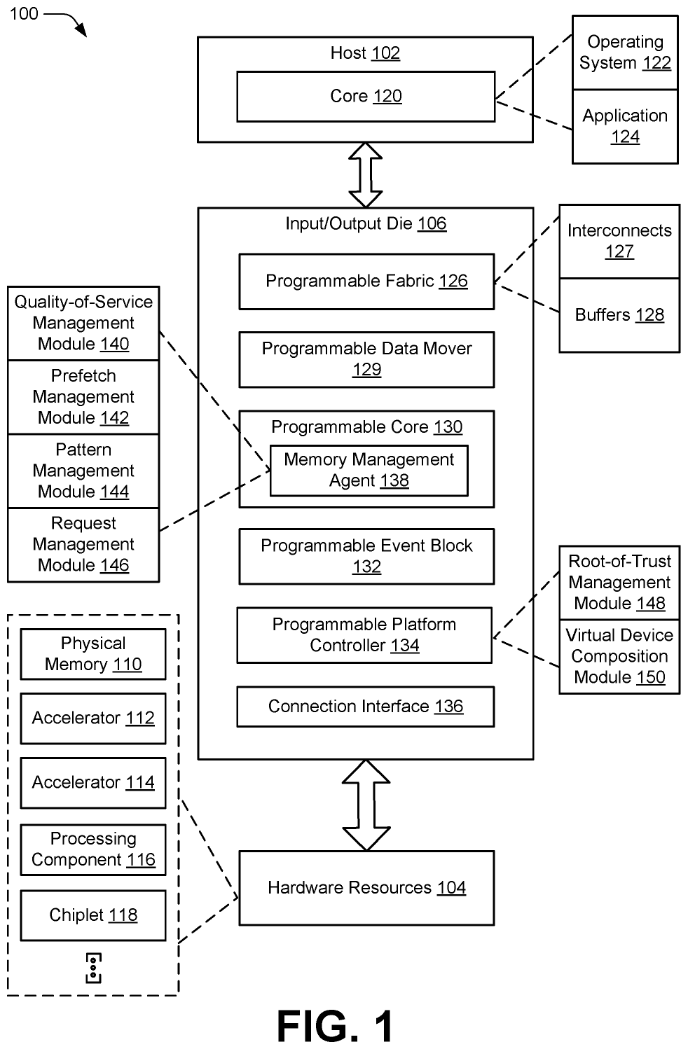

FIG. 1 is a block diagram of a non-limiting example system 100 configured to employ a programmable input/output die (IOD). The system 100 includes a host 102 and hardware resources 104 which are interconnected by an IOD 106 to enable the host 102 to utilize the hardware resources 104 for different computation tasks. The hardware resources 104, for instance, include a physical memory 110, accelerators 112, 114, a processing component 116, and a chiplet 118. These examples of the hardware resources 104 are non-limiting and the hardware resources 104 are implementable to include a variety of different types and instances of various hardware resources. In an example, the system 100 represents a disaggregated computing system in which the host 102 and one or more of the hardware resources 104 are implemented as chiplets (e.g., distinct semiconductor dies) that are connected to one another via the IOD 106.

The host 102 is configured to provide processing capability for an associated device such as a server, a desktop computing device, a portable computing device (e.g., a laptop, a smartphone, a tablet, etc.), and so forth. The host 102 includes a core 120 configured to execute an operating system 122 and an application 124. The host may be configured to access one or more of the hardware resources 104 (e.g., as a parallel computing system) via the IOD 106 to facilitate execution of at least a portion of the operating system 122 and/or application 124.

The host 102 is an electronic circuit that performs various operations on and/or using data, such as leveraging the hardware resources 104. Examples of the host 102 include, but are not limited to, a central processing unit (CPU), a graphics processing unit (GPU), a field programmable gate array (FPGA), an accelerated processing unit (APU), a digital signal processor (DSP), etc. The core 120 is a processing unit that reads and executes instructions (e.g., of a program such as operating system 122 and/or application 124). Although one core 120 is depicted in the illustrated example, in at least some implementations the host 102 includes more than one core 120, e.g., the host 102 is a multi-core processor.

The hardware resources 104 represents resources that are accessible by the host 102 to perform various computation tasks, such as data processing, data storage, etc. The hardware resources 104 are implementable in various ways, such as physical memory 110, accelerators 112, 114, processing component 116, and chiplet 118. The accelerators 112, 114, the processing component 116, and the chiplet 118 include any type of processing devices, such as a CPU, GPU, FPGA, APU, DSP, or any other circuitry wired to perform the tasks assigned thereto. In at least some implementations, the hardware resources 104 include fewer or more types or instances of various combinations of hardware resources connected via the IOD 106 to assist the host 102 with performing one or more of the data processing and/or data storage functions described above.

The physical memory 110 is a device and/or system that is configured to store information, such as for use in a device, e.g., by the core 120 of the host 102 and/or by another device IOD 106. In one or more implementations, the memory 110 corresponds to semiconductor memory where data is stored within memory cells on one or more integrated circuits. In at least one example, the memory 110 corresponds to and/or includes volatile memory, examples of which include random-access memory (RAM), dynamic random-access memory (DRAM), synchronous dynamic random-access memory (SDRAM), and static random-access memory (SRAM). Alternatively or in addition, the memory 110 corresponds to and/or includes non-volatile memory, examples of which include flash memory, read-only memory (ROM), programmable read-only memory (PROM), erasable programmable read-only memory (EPROM), and electronically erasable programmable read-only memory (EEPROM).

The IOD 106 is a device (e.g., semiconductor die, chiplet, etc.) configured to couple a plurality of devices (e.g., chiplets, chips, etc.) to one another and/or to control access to one or more of the hardware resources 104 (e.g., physical memory 110). In the illustrated example, the IOD 106 includes a programmable fabric 126, a programmable data mover 129, a programmable core 130, a programmable event block 132, a programmable platform controller 134, and a connection interface 136. In at least some implementations, the IOD 106 includes fewer or more types or instances of the components show.

In an example, the IOD 106 is configured to manage intercommunication of data among the host 102 and/or the hardware resources 104. The IOD 106, for instance, includes a programmable fabric 126 (e.g., programmable logic fabric, FPGA, etc.) that is reconfigurable to implement interconnects 127 and one or more buffers 128. The interconnects 127 and buffers 128 connect one or more components of the IOD 106 in a reconfigurable arrangement based on the configuration of the programmable fabric 126 to define data communication paths for transferring data among the host 102 and the hardware resources 104.

In an example, the programmable fabric 126 is configured to implement the interconnects 127 to connect one or more of the hardware resources 104 (e.g., combination of accelerators, chiplets, etc.) in a first network topology (e.g., mesh topology, tree topology, etc.) by configuring the interconnects 127 accordingly. Thus, the programmable fabric 126 is reconfigurable to customize a network-on-chip topology of a combination of hardware resources 104 according to a workload or chiplet configuration in the hardware resources 104. In examples, the programmable fabric 126 is reconfigurable (e.g., via a BIOS update) to implement the interconnects 127 such that one or more of the programmable data mover 129, the programmable core 130, the programmable event block 132, perform operations in-line with transferring data among hardware resources 104 along a data path defined by the interconnects 127.

The programmable data mover 129 includes circuitry, logic, firmware, processing elements, or any other type of software and/or programmable hardware device configured to perform a data operation in-line on data transferred along a data path defined by the interconnects 127 prior to transfer of the data out of the IOD 106. In an example, the programmable data mover 129 is configured to encrypt or decrypt the data prior to the data being transferred out of the IOD 106 (e.g., to host 102, accelerator 114, etc.). In an example, the programmable data mover 129 is configured to compress or decompress the data prior to the data being transferred out of the IOD 106 (e.g., to host 102, accelerator 114, etc.). As such, the programmable data mover 129 may enable performing a customized data operation in the IOD 106 instead of or in addition to performing such operation at the host 102 and/or at accelerator 112, 114 to provide computational efficiency and/or security improvements.

The programmable core 130 includes any type of processing circuitry, such as a scalar core, a CPU, GPU, FPGA, APU, DSP, or any other circuitry wired to programmably customize I/O functionalities to manage access to physical memory 110, control data routing within IOD 106, schedule tasks for execution by accelerators 112, 114, and/or control other functionalities of hardware resources 104 attached to the IOD 106. To that end, in the illustrated example, the programmable core 130 includes a reconfigurable memory management agent 138 configured to implement various functionalities for controlling memory access operations for accessing the physical memory 110.

Examples of functionality usable to manage access to physical memory 110 are illustrated as a quality-of-service (QoS) management module 140, a prefetch management module 142, a pattern management module 144, and a request management module 146. The QoS management module 140 is configured to implement quality-of-service considerations, e.g., to support priority information, deadlines for task to meet a corresponding service level agreement (SLA), and so forth. The prefetch management module 142 supports prefetching of data from the physical memory 110 to support data processing operations of the host 102, accelerators 112, 114, processing component 116, and/or chiplet 118. The pattern management module 144 is configurable to manage memory access operations based on patterns of memory access observed and/or programmed as expected memory access patterns to be encountered as part of subsequent memory access operations.

The request management module 146 is representative of functionality to manage memory access requests and/or address translation service (ATS) requests that are used to initiate respective translation operations (e.g., for translating virtual or device memory addresses to physical memory addresses). In an instance in which a device (e.g., one or the hardware resources 104) sends a request to an I/O memory management unit (IOMMU) to retrieve a request, such requests are batched and/or processed by the request management module 146 according to an request management algorithm programmably defined and/or executed by the programmable core 130 to reduce an overhead otherwise encountered in sending individual requests, e.g., by batching a plurality of address translation requests as a single request.

In examples, the IOD 106 includes programmable features (e.g., programmable core 130, etc.) for supporting enforcement of customized QoS policies. For example, in a multi-chiplet system where a first accelerator 112 requires more memory bandwidth than a second accelerator 114, the programmable core 130 is configured to contain programmable components and/or arbitration policies that provide a bias toward accelerator 112 to make better use of memory bandwidth based on expected characteristics of a heterogeneous workload executed by the accelerators 112, 114. In an example, the QoS management module 140 is configured to implement a programmable QoS policy to ensure fairness and/or provide stricter guarantees regarding SLA requirements for latency. In an example, programmable core 130 is configured to customize scheduling transactions, memory requests, interrupts, ATS requests, and/or other memory access operations depending on workload and/or hardware resource 104 configurations. In an example, the request management module 146 is configured to prioritize ATS requests based on a programmable arbitration policy such that higher priority requests are given precedence. In an example, the request management module 146 manages ATS resources or other virtual memory resources in an IOMMU in a programmable or reconfigurable manner (e.g., by execution instructions at programmable core 130 according to a specific chiplet configuration and/or workload characteristics). More generally, in an example, the programmable core 130 is configured to manage ATS requests according to a programmable ATS configuration (e.g., which may include programmable or reconfigurable ATS pre-fetching policies, ATS scheduling policies, ATS QoS policies, etc.), in line with the discussion above.

The programmable event block 132 includes logic, firmware, processing elements and/or other reconfigurable circuitry configured to provide a programmable event signaling mechanism for a hardware resource 104 (e.g., accelerator 112, 114, processing component 116, chiplet 118, etc.) to signal an event that triggers an operation by the IOD 106 and/or another hardware resource. For example, without necessarily requiring a scheduling process or other software interrupt process to be executed at the host, an accelerator 112 can use the programmable event block 132 to trigger an operation (e.g., enqueuing a task for execution by accelerator 114, modifying memory bandwidth or prefetching algorithm or QoS policy, etc.) directly to IOD 106 by sending a signal (e.g., virtual memory address, etc.) to trigger performance of the operation by the IOD 106.

The programmable platform controller 134 includes circuitry, logic, firmware, processing elements, or any other type of software and/or programmable hardware device configured as a virtual device configuration manager that is implemented in the IOD 106 to securely and efficiently provide a root-of-trust (RoT) to configure and compose a virtual hardware resource (e.g., virtual device, virtual machine, virtual accelerator, virtualized hardware, etc.) from one or more of the hardware resources 104 (e.g., by executing the virtual device composition module 150). For example, ROT management module 148 is configured as a trusted source to provide a root-of-trust (e.g., data encryption keys, certificate validation, secure boot management, etc.) for composing a virtual hardware resource (e.g., virtualized hardware composed from accelerators 112, 114, etc. as a virtual machine). With the advent of scalable I/O virtualization (SIOV) technology, some implementations involve using software to compose virtual devices. Conventionally, such processes are implemented by the host 102 (e.g., by executing operating system 122).

In examples described herein, virtual device configuration and composition is additionally or alternatively performed at the IOD 106 using the programmable platform controller 134. For example, secure software or firmware (e.g., ROT management module 148, virtual device composition module 150) is loaded onto the IOD 106 and executed by the programmable platform controller 134 to provide ROT verification, virtual device configuration and/or composition services locally at the IOD 106 (e.g., instead of the host 102), thereby providing security, scalability, and/or computation efficiency improvements over conventional systems that implement these functionalities at the host 102. In an example, the programmable platform controller 134 composes a virtual hardware resource or virtual device that includes two or more distinct accelerators (e.g., accelerators 112, 114) from the hardware resources 104.

The connection interface 136 includes one or more serial communication channels to facilitate establishing data links (and/or control links) between the IOD 106, the host 102, and/or each of the hardware resources 104. In at least some implementations, the connection interface 136 is utilized to implement PCIe-based data communication between the IOD 106, the physical memory 110, the accelerators 112, 114, the processing component 116, and/or the chiplet 118. Alternative or additional examples of interfaces used to connect the IOD 106 with the host 102, the accelerators 112, 114, the processing component 116, and/or the chiplet 118 for communication over the connection interface 136 include, by way of example and not limitation, CXL, Global Memory Interconnect (GMI), NVLink, among others. It is to be appreciated that in one or more implementations the IOD 106 communicates with the host 102 and each of the hardware resources 104 using a different interface from those mentioned just above without departing from the spirit or scope of the described techniques.

In some examples, the programmable core 130 is configured to implement programmable arbitration policies to manage I/O data communications among different types of I/O connection interfaces 136 (e.g., optical I/O interconnects of a chiplet such as chiplet 118, serializer/deserializer (SerDes) interface of a die-to-die data connection between IOD 106 and accelerator 112, etc.). Thus, in examples, the IOD 106 is configured to programmably manage data communications among different types of custom or heterogeneous chiplet interfaces (e.g., CXL, UCIe, GMI, etc.).

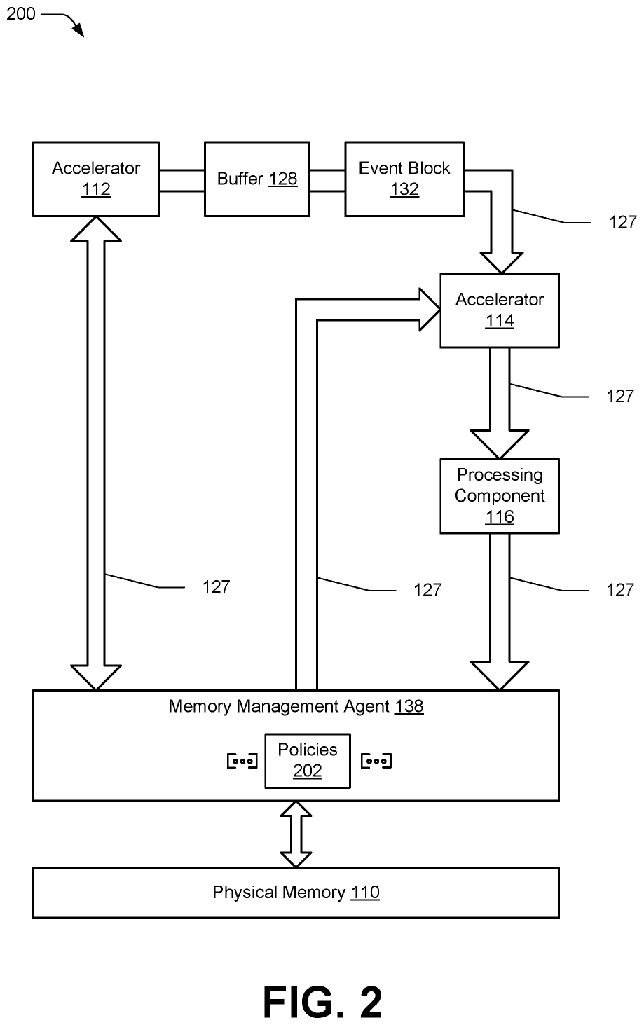

FIG. 2 is a block diagram of a non-limiting example system 200 configured to connect a plurality of devices (e.g., accelerators, 112, 114, and processing component 116) in a network topology defined by interconnects 127 based on a configuration of programmable fabric 126.

In examples, system 200 represents a disaggregated hardware resource (e.g., hybrid accelerator) implemented using the IOD 106 of the system 100. For instance, one or more chiplets (e.g., accelerators 112, 114, etc.) of the system 100 are coupled in a particular topology using the IOD 106 (e.g., by reconfiguring interconnects 127, buffers 128, etc.) to implement the system 200 as a disaggregated hardware resource accessible to the host 102 via the IOD 106.

In the illustrated example, the programmable fabric 126 is configured to implement interconnects 127 to connect accelerators 112, 114, and processing component 116 in a specific network topology that is suitable for a specific type of workload (e.g., a hybrid accelerator architecture for processing graph neural networks, etc.). For example, in system 200, the interconnects 127 define a data path (through the IOD 106) for routing data output from accelerator 112 (e.g., a graph analyzer accelerator) to the accelerator 114, with a specific bandwidth, and routing data output from accelerator 114 to processing component 116. Further, in the data path defined between accelerators 112, 114, the buffer 128 is implemented (e.g., as an aggregation buffer) to hold data output from accelerator 112 until a sufficient amount of data is available to trigger execution of a task by accelerator 114 to process the data in the buffer 128. For instance, the accelerator 112 sends an asynchronous event signal to programmable event block 132, which triggers the IOD 106 to enqueue a task for the accelerator 114 to process the data in the buffer 128 (and for IOD 106 to transmit the data in the buffer 128).

Further, in this example of a heterogeneous acceleration workload, the memory management agent 138 can be controlled to optimize memory access requests from accelerators 112, 114 dynamically (e.g., depending on which phase of the acceleration process is occurring) by adjusting policies 202 (e.g., arbitration policies, memory bandwidth settings, QoS policies, transaction scheduling, prefetching rules, etc.) according to rules that would optimize the hybrid acceleration process specific to the workload being executed by the system 200.

In alternate examples, the programmable fabric 126 reconfigures the interconnects 127 to connect a different combination hardware resources in a different network topology (e.g., mesh topology, tree topology, etc.) with or without buffer 128, event block 132, etc., when executing a different workload (e.g., a convolutional neural network machine learning workload, etc.).

Thus, the IOD 106 advantageously enables modifying the behavior and/or characteristics (e.g., network-on-chip topology, etc.) to optimize the configuration of the same hardware resources (and/or different hardware resources), and/or the memory access rules, QoS policies, scheduling techniques, etc., dynamically and strategically with the same IOD 106 hardware depending on workload characteristics and/or available hardware resource capabilities.

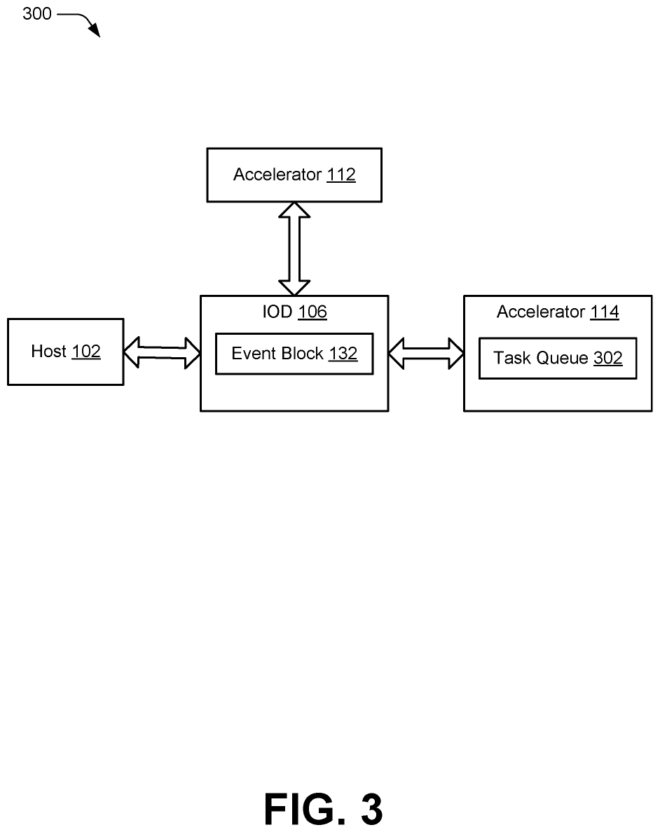

FIG. 3 is a block diagram of a non-limiting example system 300 showing a configuration where a first accelerator 112 uses the programmable event block 132 of the IOD 106 to asynchronously enqueue a task for execution in a task queue 302 of a second accelerator 114.

In examples, system 300 includes a disaggregated hardware resource implemented using the IOD 106. For instance, one or more chiplets (e.g., accelerators 112, 114, etc.) of the system 100 are coupled in a particular topology defined by the IOD 106 (e.g., by configuring event block 132 to enable asynchronous event signaling and data signaling among the accelerators 112 and 114) to implement a disaggregated hardware resource accessible to the host 102 via the IOD 106.

In the illustrated example, the IOD 106 composes a disaggregated hardware resource, accessible to the host 102 via the IOD 106, that includes accelerators 112 and 114 (e.g., with or without processing component 116) in a particular topology. For instance, the IOD 106 configures interconnects between the accelerators 112, 114 and implements an asynchronous event signaling mechanism (e.g., via event block 132) for the accelerators 112, 114 to efficiently execute a specialized workload (e.g., graph convolution network machine learning workload, etc.) for the host 102.

In the illustrated example, the accelerator 112 executes a first computation phase of a hybrid acceleration workload. The accelerator 112 then sends an asynchronous event signal to the event block 132 (e.g., virtual memory address, etc.) to trigger enqueuing a task in the task queue 302 for execution by the accelerator 114 (e.g., a second computation phase of the hybrid acceleration workload) directly without relying on a software interrupt from the host 102 to signal the event to the accelerator 114 for instance.

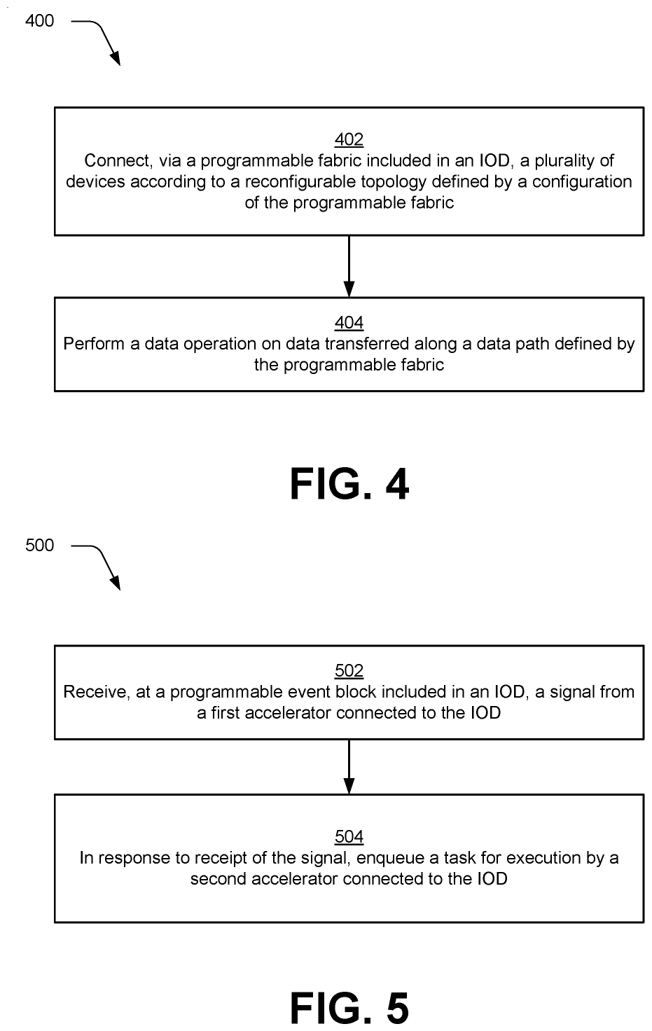

FIG. 4 depicts a procedure 400 in an example implementation of a programmable IOD connecting a plurality of devices according to a reconfigurable topology. At block 402, a programmable fabric 126 included in an IOD 106 connects a plurality of devices (e.g., accelerators 112, 114, processing component 116, and/or chiplet 118) in a reconfigurable network topology (e.g., the topology shown in FIG. 2 or FIG. 3) based on a configuration of the programmable fabric 126. For example, interconnects 127 are programmably configured (e.g., via firmware, FPGA, BIOS settings, etc.), to connect the plurality of devices (e.g., CPUs, GPUs, etc.) in a specific network topology (e.g., mesh, tree, chain, etc.) defined by the configuration of the programmable fabric 126. At block 404, a programmable data mover 129 performs a data operation (e.g., encryption, decryption, compression, decompression, etc.) in-line on data transferred along a data path defined by the programmable fabric 126, in line with the discussion above.

FIG. 5 depicts a procedure 500 in an example implementation of a programmable event signaling mechanism implemented using a programmable IOD to enable asynchronous event signaling between two accelerators. At block 502, a programmable event block 132 included in an IOD 106 receives a signal from a first accelerator 112 connected to the IOD 106, in line with the discussion above with respect to FIGS. 2-3. At block 504, the IOD 106, in response to receipt of the signal, enqueues a task for execution by a second accelerator 114 connected to the IOD 106. For example, the IOD 106 enqueues the task in task queue 302 of accelerator 114.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the host 102, hardware resources 104, and/or the IOD 106) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A system comprising:
an input/output die (IOD) that couples a plurality of devices; and
a programmable fabric included in the IOD, the programmable fabric configured to implement interconnects for connecting the plurality of devices according to a reconfigurable topology defined by a configuration of the programmable fabric.

2. The system of claim 1, wherein the plurality of devices includes one or more chiplets coupled via the IOD to implement a disaggregated hardware resource accessible to a host via the IOD.

3. The system of claim 1, further comprising:
a programmable data mover included in the IOD, the programmable data mover implemented along a data path defined by the interconnects based on the configuration of the programmable fabric, the programmable data mover configured to perform a data operation on data transferred along the data path.

4. The system of claim 3, wherein the data operation includes encryption or compression of the data prior to transferring the data out of the IOD.

5. The system of claim 1, further comprising:
a programmable core included in the IOD, the programmable core configured to control memory access operations for accessing a physical memory via the IOD.

6. The system of claim 5, wherein the programmable core is configured to control access to the physical memory by the plurality of devices according to a reconfigurable quality-of-service policy or a reconfigurable arbitration policy.

7. The system of claim 5, wherein the programmable core is configured to prefetch data from the physical memory according to a programmable prefetching configuration.

8. The system of claim 5, wherein the programmable core is configured to schedule memory requests from the plurality of devices according to a programmable scheduling configuration.

9. The system of claim 5, wherein the programmable core is configured to manage address translation service (ATS) requests from the plurality of devices according to a programmable ATS configuration.

10. The system of claim 1, further comprising:
a programmable event block included in the IOD, the programmable event block configured to:
receive a signal from a first device of the plurality of devices; and
trigger performance of an operation in response to receipt of the signal.

11. The system of claim 10, wherein the first device of the plurality of devices is a first accelerator and a second device of the plurality of devices is a second accelerator, wherein the operation includes the IOD to enqueue a task for execution by the second accelerator in response to the receipt of the signal from the first accelerator.

12. The system of claim 1, further comprising:
a programmable platform controller included in the IOD, the programmable platform controller configured to compose one or more of the plurality of devices into a configuration that implements a virtual hardware resource for executing a workload.

13. The system of claim 12, wherein the programmable platform controller is configured to provide a root-of-trust for composition of the plurality of devices to implement one or more virtual hardware resources.

14. A method comprising:
connecting, via a programmable fabric included in an input/output die (IOD), a plurality of devices according to a reconfigurable topology defined by a configuration of the programmable fabric.

15. The method of claim 14, further comprising:
performing, at a programmable data mover included in the IOD along a data path defined by the programmable fabric, a data operation on data transferred along the data path.

16. The method of claim 14, further comprising:
controlling, by a programmable core included in the IOD, memory access operations for accessing a physical memory via the IOD.

17. The method of claim 14, further comprising:
receiving, at a programmable event block included in the IOD, a signal from a first accelerator connected to the IOD; and
in response to receipt of the signal, enqueue a task for execution by a second accelerator connected to the IOD.

18. The method of claim 14, further comprising:
composing, via a programmable platform controller included in the IOD, one or more of the plurality of devices into a configuration that implements a virtual hardware resource for executing a workload.

19. An input/output die (IOD) comprising:
a programmable fabric configured to implement interconnects for connecting a plurality of devices according to a reconfigurable topology defined by a configuration of the programmable fabric.

20. The IOD of claim 19, wherein the plurality of devices include a host and one or more chiplets, wherein the one or more chiplets are coupled via the IOD to implement a disaggregated hardware resource accessible to the host via the IOD.
